(19) United States
(12) Patent Application Publication
(10) Pub. No.: US 2018/0088285 A1
(43) Pub. Date: Mar. 29, 2018

(54) FIBER END FACE CLEANING TAPES WITH MICRO-CAPSULE CLEANING AGENTS; AND METHODS

(71) Applicant: CommScope Technologies LLC, Hickory, NC (US)

(72) Inventors: Dennis Marvin BRAUN, Waconia, MN (US); Gary William ADAMS, Holly Springs, NC (US); Jan WATTÉ, Grimbergen (BE); Danny Willy August VERHEYDEN, Gelrode (BE); Matthew Peter GALLA, Holly Springs, NC (US)

(21) Appl. No.: 15/711,251

(22) Filed: Sep. 21, 2017

Related U.S. Application Data
(60) Provisional application No. 62/401,492, filed on Sep. 29, 2016.

(51) Int. Cl. G02B 6/38; C11D 17/00; B08B 1/00

(52) U.S. Cl. CPC G02B 6/3866; B08B 2240/02; B08B 1/001; C11D 17/0039

(57) ABSTRACT

Aspects and techniques of the present disclosure relate to a cleaning substrate with liquid-filled microcapsules embedded therein. The cleaning substrate may include cleaning swabs, tapes, or textiles that can be used to provide enhanced cleaning of optical fiber end faces. Cleaning is achieved by bringing the liquid-filled microcapsules into contact with a surface of application, such as an end face of an optical fiber connector. When the cleaning substrate is rubbed in contact with the surface of application, liquid burst from the liquid-filled microcapsules of the cleaning substrate to remove foreign matter or contamination, such as oil and dust, from the surface of application.

### CROSS-REFERENCE TO RELATED APPLICATION

The present application claims the benefit of U.S. Provisional Patent Application Ser. No. 62/401,492, filed Sep. 29, 2016, which application is hereby incorporated by reference in its entirety.

### TECHNICAL FIELD

The present disclosure relates generally to optical fiber communication systems. More particularly, the present disclosure relates to field preparation tools used to clean an end face of a fiber optic connector.

### BACKGROUND

Fiber optic communication systems are becoming prevalent in part because service providers want to deliver high bandwidth communication capabilities (e.g., data and voice) to customers. Fiber optic communication systems employ a network of fiber optic cables to transmit large volumes of data and voice signals over relatively long distances. Fiber optic connectors are an important part of most fiber optic communication systems. Fiber optic connectors allow optical fibers to be quickly optically connected without requiring a splice. Fiber optic connectors can include single fiber connectors and multi-fiber connectors. One example of an existing single-fiber fiber optic connection system is described at U.S. Pat. Nos. 6,579,014; 6,648,520; and 6,899,467, which are hereby incorporated by reference in their entireties. An example of a multi-fiber connection system is disclosed at U.S. Pat. No. 5,214,730, the disclosure of which is hereby incorporated herein by reference in its entirety.

A typical fiber optic connector includes a ferrule assembly supported at a distal end of a connector housing. The ferrule assembly can include a multi-fiber ferrule mounted in a hub. A spring is used to bias the ferrule assembly in a distal direction relative to the connector housing. The multi-fiber ferrule functions to support the end portions of multiple optical fibers. The multi-fiber ferrule has a distal end face at which polished ends of the optical fibers are located. When two multi-fiber fiber optic connectors are interconnected, the distal end faces of the multi-fiber ferrules oppose and are biased toward one another by their respective springs. With the multi-fiber fiber optic connectors connected, their respective optical fibers are coaxially aligned such that the end faces of the optical fibers directly oppose one another. In this way, optical signals can be transmitted from optical fiber to optical fiber through the aligned end faces of the optical fibers.

As indicated above, multi-fiber ferrules are configured for supporting the ends of multiple optical fibers. Typically, the optical fibers are arranged in one or more rows within the multi-fiber ferrule. When two multi-fiber ferrules are interconnected, the fibers of the rows of optical fibers align with one another. For most multi-fiber ferrules, it is desirable for the optical fibers to protrude distally outwardly from the distal end faces of the multi-fiber ferrules. This type of protrusion can assist in making physical fiber-to-fiber contact when two multi-fiber connectors are mated. U.S. Pat. No. 6,957,920, which is hereby incorporated by reference in its entirety, discloses a multi-fiber ferrule having protruding optical fibers of the type described above.

Contamination and defects on the end face of a fiber optical connector is a major concern that can degrade the performance of the connector. For example, small scratches (e.g., on the order of micro-meters) and dust particles can greatly impact the performance of the connector. Accordingly, field cleaning tools are designed to remove contaminants from the end face of the ferrule of the connector.

While various applicator pads have been used in the prior art to clean polished end faces of optical fibers, improvements are desirable in this area.

### SUMMARY

Aspects of the present disclosure relate to a cleaning tape member for cleaning optical fiber connectors. The cleaning tape member can include liquid-filled microcapsules that are embedded in the cleaning tape member. When the cleaning tape member is rubbed in contact with a surface of application, liquid can burst from the microcapsules within the cleaning tape member due to the rubbing pressure and the liquid can be applied to the surface of application for removing contaminants therefrom.

Features of the present disclosure also relate to a method of using a tool for cleaning at least one surface of an optical fiber connector. The tool can include a body and a cleaning tip on the body. The cleaning tip can have a distal end portion configured to align the at least one surface with the cleaning tip. The tool further includes a cleaning tape member disposed in the body of the tool and extending along a path that exposes the cleaning tape member at the distal end portion of the cleaning tip for engaging the at least one surface of the optical fiber connector. The cleaning tape member includes liquid-filled microcapsules that can be embedded in the cleaning tape member. When the cleaning tape member engages the at least one surface of the optical fiber connector, the liquid burst from the microcapsules within the cleaning tape member and the liquid is applied to the at least one surface of the optical fiber connector. The tool can have a mechanism for selectively advancing the cleaning tape member along the path to wipe contaminants from the at least one surface when the cleaning tip is engaged with the at least one surface of the optical fiber connector. The microcapsules can remain intact during the advancement of the cleaning tape member until the cleaning tape member engages the at least one surface of the optical fiber connector to release the liquid from the microcapsules.

These and other features and advantages will be apparent from a reading of the following detailed description and a review of the associated drawings. A variety of additional aspects will be set forth in the description that follows. These aspects can relate to individual features and to combinations of features. It is to be understood that both the foregoing general description and the following detailed description are exemplary and explanatory only and are not restrictive of the broad concepts upon which the embodiments disclosed herein are based.

### BRIEF DESCRIPTION OF THE DRAWINGS

FIGS. 1-3 are schematic diagrams of an example tool for cleaning at least one surface of an optical fiber connector;

FIG. 4 is a cross-sectional top view of a pair of multi-fiber optic ferrules in accordance with the principles of the present disclosure;

FIG. 5 is a cross-sectional view of the multi-fiber optic ferrule of FIG. 4, as viewed along sight line A₁;

FIG. 6 is a schematic diagram of an example cleaning tape member in accordance with principles of the present disclosure;

FIG. 7 is a microscopic view of the cleaning tape member shown in FIG. 6 depicting liquid-filled microcapsules embedded therein; and

FIG. 8 is a perspective end view of the tool of FIG. 1 with the cleaning tape member exposed on a cleaning tip thereof.

### DETAILED DESCRIPTION

Reference will now be made in detail to the exemplary aspects of the present disclosure that are illustrated in the accompanying drawings. Wherever possible, the same reference numbers will be used throughout the drawings to refer to the same or like structure.

The present disclosure generally relates to liquid-filled microcapsules embedded in combination with a variety of cleaning swabs, tapes, or textiles to provide enhanced cleaning of optical fiber end faces. Cleaning is achieved by bringing the microcapsules into contact with an end face to remove foreign matter or contamination, such as oil and dust, from the end faces of optical fiber connectors. It will be appreciated that the end faces of optical fiber may be cleaned with swiping actions.

There are many conventional methods available today for cleaning a fiber optic connector. One common approach is to use a separate cleaning solution that can be applied directly onto the connector or onto swabs to remove contaminants from the fiber optic connector. For example, KimWipes® and cotton swabs, are many commercial-off-the-shelf materials used to clean connector end faces. For example, cleaning of a connection end face has generally been performed with a cotton swab soaked in alcohol or a tape-type cleaner, with wiping and cleaning performed by placing the cleaner, gripped directly by hand, up against the connection end face of the optical connector.

There are several cleaning tool devices commercially available that are used to clean connector end faces. One popular device is the IBC™ Brand Cleaner, although alternatives are possible. For example, one-click type pen fiber optic cleaners. One example of an existing cleaning tool device is described at U.S. Pat. No. 8,079,111, which is hereby incorporated by reference in its entirety.

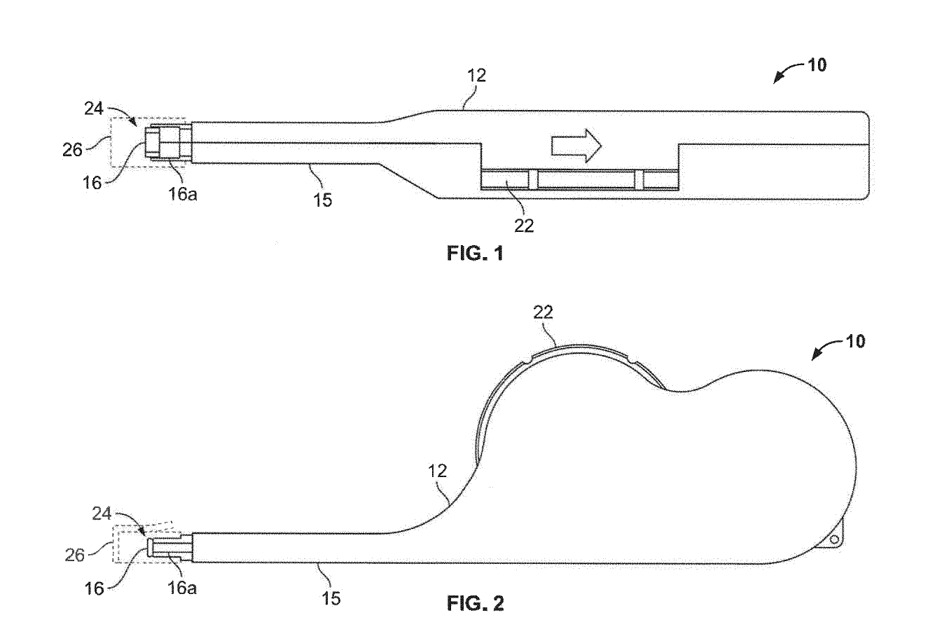

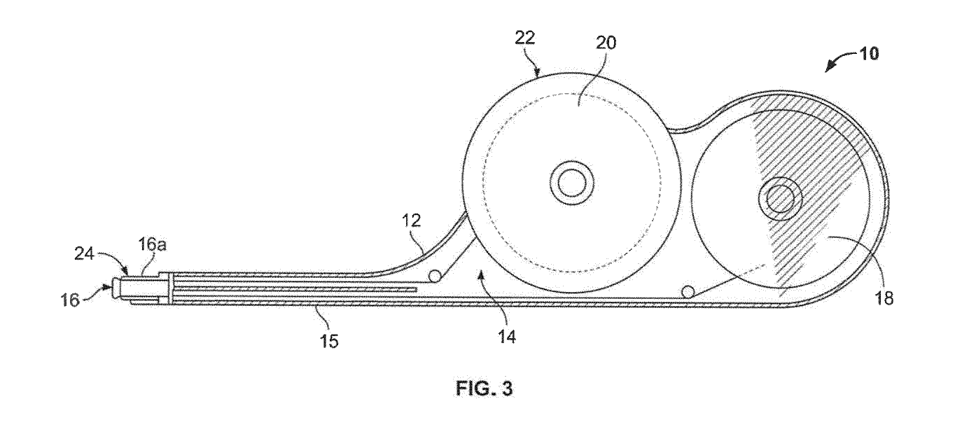

FIG. 1 depicts an example optical component cleaning tool 10 (e.g., cleaning device) that performs wiping and cleaning of a connection end face of an optical connector by movement of a cleaning substrate therein. The optical component cleaning tool 10 can include a tool body 12; a driving mechanism 14 (e.g., tape dispenser) that moves the cleaning substrate; and a cleaning tip 16 having a projected distal end portion 16a of a protruding portion 15 that protrudes from the tool body 12, with a cleaning substrate being disposed at the projected distal end portion 16a of the tool body 12, although alternatives are possible.

The distal end portion 16a can be configured to align a surface of an optical fiber connector with the cleaning tip 16. The cleaning substrate can be disposed in the tool body 12 and extend along a path that exposes the cleaning substrate at the projected distal end portion 16a of the cleaning tip 16 for engaging with the surface of the optical fiber connector.

In one example, the driving mechanism 14 can be provided with a supply reel 18 wound with the cleaning substrate, a take-up reel 20 that takes up and collects the cleaning substrate after use, and an operation dial 22 that operates the cleaning substrate. The driving mechanism 14 can be driven by operating the operation dial 22 by finger or the like to rotate it in a prescribed direction. More specifically, by rotation of the operation dial 22, the take-up reel 20 rotates to take up the cleaning substrate, and unused, new, clean strip of cleaning substrate can be unreeled from the supply reel 18 and indexed or fed. The driving mechanism 14 positioned in the tool can selectively advance the cleaning substrate along a path to wipe contaminants from the surface of the optical fiber connector when the cleaning tip 16 is engaged with the surface of the optical fiber connector. It will be appreciated that the surface can be at least one of an end face of the connector and any other surface of the connector.

The cleaning tip 16 can be disposed on the distal end portion 16a of the optical component cleaning tool 10, which causes the cleaning substrate to abut a connection end face of a ferrule. The cleaning tip 16 over which the cleaning substrate is wound and the distal end portion 16a of the protruding portion 15 in which the cleaning tip 16 is incorporated make up an insertion portion 24 that is able to be inserted into or against an optical fiber connector or optical adapter. In certain examples, an end cap 26 can be attached at the distal end portion 16 of the tool body 12 to block any ingress of debris, dust, water and the like into the optical component cleaning tool 10, thereby enabling the internal space of the optical component cleaning tool 10 to be constantly maintained in a clean state.

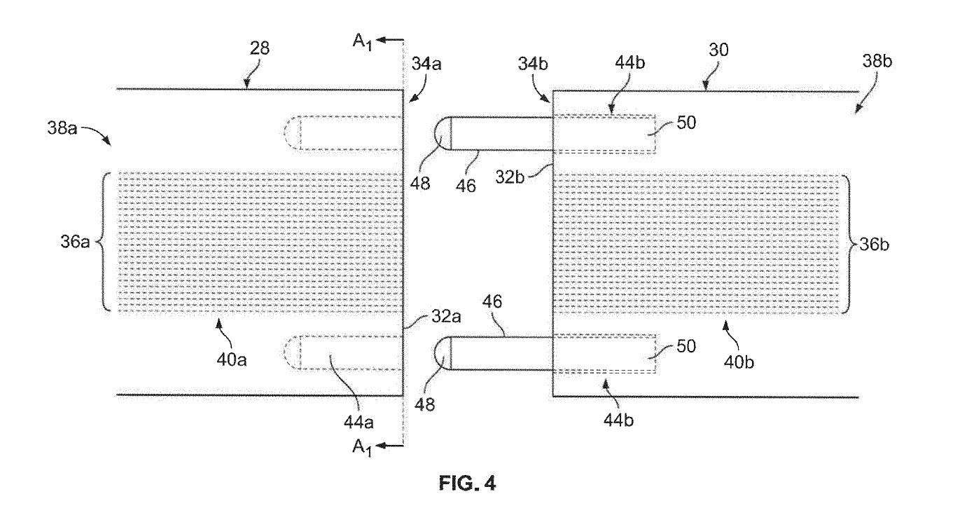

FIG. 4 illustrates an example female ferrule 28 and a male ferrule 30 adapted to be coupled together. When the ferrules 28, 30 are coupled together (i.e., mated) optical fibers supported by the female ferrule 28 are optically coupled to corresponding optical fibers supported by the male ferrule 30.

In some aspects, the female ferrule 28 and the male ferrule 30 may each include a contact face 32a, 32b (e.g., end face) at a front end 34a, 34b of the ferrules 28, 30. In some implementations, the female ferrule 28 and the male ferrule 30 may each define fiber passages 36a, 36b that extend through a depth of the female and male ferrules 28, 30 from a rear end 38a, 38b of the female and male ferrules 28, 30 to the front end 34a, 34b of the female and male ferrules 28, 30. It is critical to keep an optical connector end face clean to allow for proper transmission, and thus, reduce any loss of data during use.

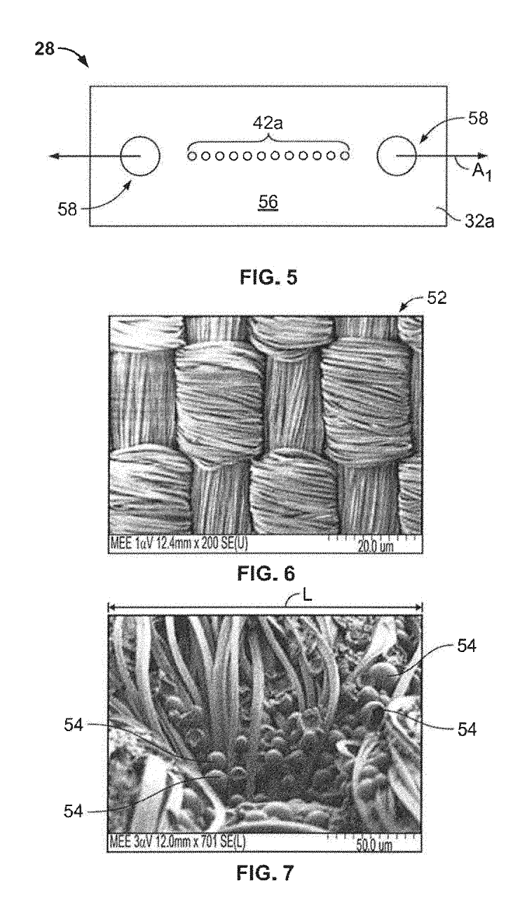

Referring to FIG. 5, in some aspects the fiber passages 36a, 36b may be arranged in a row that extends along a major axis A₁ of the contact face 32a, 32b. In some aspects there may be multiple rows of fibers. The female ferrule 28 and the male ferrule 30 each may include a plurality of optical fibers 40a, 40b that extend through the fiber passages 36a, 36b. Example optical fibers 40a, 40b include material (e.g., a glass core surrounded by a glass cladding layer) that transmits optical information/signals.

As depicted, the optical fibers 40a may include an end face 42a that is accessible at the contact face 32a at the front end 34a of the female ferrule 28. The same can be said of the male ferrule 30. In use, the example optical fiber end faces 42a, 42b (not shown) may contact each other to transmit optical signals between the optical fibers 40a, 40b.

In some implementations, the female ferrule 28 and the male ferrule 30 each may define a pair of alignment pin openings 44a, 44b (e.g., guide pin holes) (see FIG. 4). In some aspects, the alignment pin openings 44a, 44b may extend rearwardly from contact face at the front end 34a, 34b of the female and male ferrules 28, 30. As depicted, the optical fibers 40a, 40b of each female and male ferrule 28, 30 may be positioned between each pair of alignment feature openings 44a, 44b. In some implementations, the male ferrule 30 may include a pair of alignment pins 46 (e.g., guide pins), for example a pair of alignment pins 46 with distal point contacts 48 that can be rounded distal tips, and proximal base end portions 50 positioned and supported within the alignment pin opening 44b. The proximal base end portions 50 may be permanently secured within the alignment pin openings 44b.

Connectors can become contaminated while they are unmated and when the contact faces 32a, 32b are exposed to potential contaminants. If a connector contact face comes in contact with a dirty surface, contaminants will likely stick to the contact face. For example, this may happen during equipment maintenance, when a technician removes a connector and fails to place a protective end cap over the ferrule. Also, there is the possibility of touching the connector end face with one's fingers, which may be where a majority of oil contaminations originate. Because of this, it is desirable to have an effective product for cleaning connector end faces, fiber ends, or other surfaces of the connector. It will be appreciated that although connector end faces are illustrated for cleaning purposes, connector housings, adapters, etc. may also be cleansed in accordance with the present disclosure.

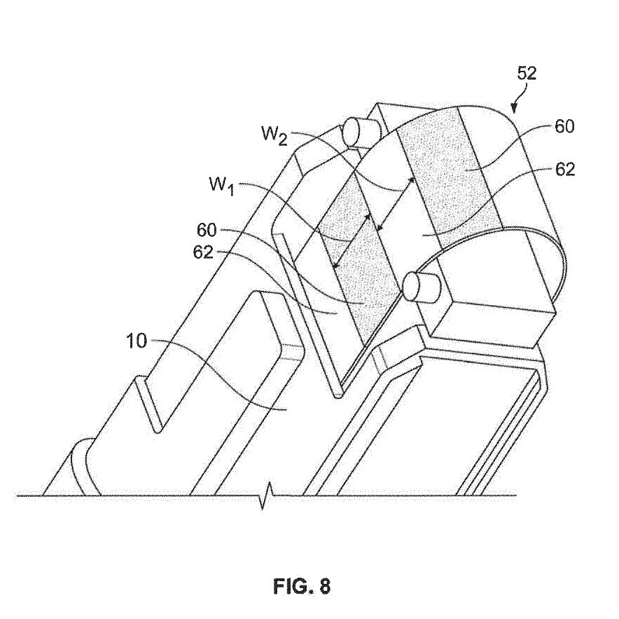

Referring to FIGS. 6 and 7, an example cleaning substrate 52 (e.g., cleaning tape member) is depicted. The cleaning substrate 52 can be used to clean connection end faces of optical fiber connectors. The cleaning substrate 52 can be made with a textile fiber, such as, a cellulosic fiber, a polyamide fiber, a wool fiber or acrylic or modacrylic fibers, although alternatives are possible. For example, the cleaning substrate 52 may be a polyester substrate. In other examples, the cleaning substrate 52 may include a weave pattern, although alternatives are possible.

As depicted in FIG. 7, the cleaning substrate 52 can include liquid-filled microcapsules 54 that are embedded within the cleaning substrate 52. The liquid-filled microcapsules 54 can each include functional groups on its outer shell face that impart an affinity towards the fibers to create a strong bond between the microcapsules and the fibers. In certain examples, the liquid-filled microcapsules 54 can include reactive functional groups that chemically bond to a textile, fabric, or other surface without needing a separate adhesive composition to be applied to the textile or fabric.

Examples of suitable reactive functional groups include groups such as acid anhydride groups, amino groups, N-substituted amino groups and their salts, epoxy groups (such as cyclohexyl epoxy groups), glycidyl groups, hydroxyl groups, isocyanate groups, urea groups, aldehyde groups, ester groups, ether groups, alkenyl groups, alkynyl groups, thiol groups, disulphide groups, silyl or silane groups, glyoxal-based groups, aziridine-based groups, groups based on active methylene compounds or other b-dicarbonyl compounds (such as 2,4-pentadione, malonic acid, acetylacetone, ethylacetone acetate, malonamide, acetoacetamide and its methyl analogues, ethyl acetoacetate and isopropyl acetoacetate), halo groups and hydrides. Polar groups (i.e. positively or negatively charged, zwitterionic or amphoteric groups) or hydrogen bonding groups may also be considered as reactive functional groups, but groups having reactive moieties providing covalent bonding may also be used.

In certain examples, the liquid-filled microcapsules 54 can comprise a thin, self-supporting, polymeric shell around particles of a desired liquid agent. The liquid-filled microcapsules 54 can be friable in nature. As used herein, the term “friability,” in this context, refers to the propensity of the liquid-filled microcapsules 54 to rupture or break open when subjected to direct external pressures or shear forces. For controlled release of liquid, the liquid-filled microcapsules 54 can be applied so that they are exposed to friction to subsequently rupture (e.g., tear, burst) and release the liquid within. The liquid-filled microcapsules 54 can remain intact (e.g., not rupture) during the advancement of the cleaning substrate 52. When the cleaning substrate 52 engages a surface of the optical fiber connector, the contact can cause the liquid-filled microcapsules 54 to rupture and release the liquid therefrom.

In certain examples, the liquid is a cleaning agent, although alternatives are possible. The cleaning agent can include methylcyclohexane, d-Limonene, and/or sodium dodecyl sulfate, although alternatives are possible. In certain examples, the liquid includes at least 99% methylcyclohexane and no more than 1% sodium dodecyl sulfate. In other examples, the liquid includes at least 99% d-Limonene and no more than 1% sodium dodecyl sulfate. In some examples, at least 50% of the liquid-filled microcapsules 54 contain methylcyclohexane and at least 50% of the liquid-filled microcapsules contain d-Limonene in the cleaning substrate 52. In certain examples, a percentage of the liquid-filled microcapsules 54 that contain methylcyclohexane is at least within about 10% to about 75% and the percentage of the liquid-filled microcapsules 54 that contain d-Limonene is at least within about 10% to about 75%. In other examples, the liquid-filled microcapsules 54 may be immiscible in water. For example, the liquid-filled microcapsules 54 may be liquid between negative 40 degrees C. and 85 degrees C.

While under moderate pressure, the liquid-filled microcapsules 54 can each burst, discharging their liquid fill. That is, when the cleaning substrate 52 is rubbed in contact with a surface of application (e.g., connection end face of an optical fiber connector, or any surface of the optical fiber connector, or optical adapter, etc.) liquid can burst from the liquid-filled microcapsules 54 that are embedded within the cleaning substrate 52 due to moderate rubbing pressure. Once the liquid-filled microcapsules 54 are ruptured, liquid is then freed from the liquid-filled microcapsules 54 and can be applied to a surface of application for removing contaminants therefrom. In certain examples, the surface of application is an end face of a fiber optic connector. It will be appreciated that the cleaning substrate 52 may be used for other types of surface applications.

The liquid-filled microcapsules 54 may vary in size, and may have diameters ranging from about 1 micron to about 300 microns. Typically, the liquid-filled microcapsules 54 have diameters that range from about 2 microns to about 100 microns. Usually, the liquid-filled microcapsules 54 have diameters that range from about 2 microns to about 50 microns. Of course, alternate diameters of the liquid-filled microcapsules 54 are possible. For example, the liquid-filled microcapsules 54 can have an average diameter in a range from about 200 microns to about 1000 microns. In other examples, the liquid-filled microcapsules 54 can have a diameter in a range from about 300 microns to about 600 microns.

Although the cleaning substrate 52 can be referred to as a cleaning tape, the cleaning substrate 52 is not particularly limited, and can be a suitable cleaning fabric (unwoven or woven fabric) processed into a tape shape. For example, those made from an extra-fine fiber such as polyester or nylon, although alternatives are possible.

Referring to FIG. 8, the optical component cleaning tool 10 is depicted with the cleaning substrate 52. In certain examples, the cleaning substrate 52 can provide for about 400 cleans, although alternatives are possible. The optical component cleaning tool 10 can be refillable with the cleaning substrate 52 as needed. By rotating the operation dial 22, the take-up reel 20 rotates to take up the cleaning substrate 52 such that the cleaning substrate 52 is drawn over the end face 42a, 42b of the ferrules 28, 30, respectively. For example, the cleaning substrate 52 can perform wiping and cleaning of a central region 56 (see FIG. 5) located between guide-pin holes 44a or guide pins 46 on ferrules 28, 30. The cleaning substrate 52 can further perform wiping and cleaning of outside regions 58 surrounding the guide-pin holes 44a or guide pins 46. This enables efficient cleaning of the central region 56 and the outside regions 58 of a connection end face 32a, 32b. As the operation dial 22 is rotated, an unused, new, clean strip of cleaning substrate 52 can be unreeled from the supply reel 18 and indexed or fed.

A simple rotation of the operation dial 22 makes cleaning connectors quick and easy. The operation dial 22 can be arranged and configured to advance the cleaning substrate 52 while effectively and gently cleaning an end-face of the connector. In certain examples, an end face of a connector or other surface is passed through a lightly moistened area 60 (e.g., first section) on the cleaning substrate 52, and then drawn into a dry area 62 (e.g., second section). The moistened area 60 is defined as the functionalized sections on the cleaning substrate 52 that includes the liquid-filled microcapsules 54 due to the liquid-filled microcapsules 54 being configured to burst upon applied pressure against a desired surface to be cleaned.

In certain examples, the moistened area 60 and the dry area 62 can alternate between each other to provide an alternating wet and dry pattern. As a result, it is possible, for example, to wipe clean an end face or other surface of a connector with the moistened area 60, which can be followed by the dry area 62 to wipe and dry the surface. In certain examples, the cleaning substrate 52 can include a plurality of moistened areas 60 (e.g., plurality of first sections) positioned in first discrete lanes along a length L (see FIG. 7) of the cleaning substrate 52 and can include a plurality of dry areas 62 (e.g., plurality of second sections) spaced from the plurality of moistened areas 60 that are positioned in second discrete lanes along the length L of the cleaning substrate 52. The liquid-filled microcapsules 54 can be positioned within each one of the plurality of moistened areas 60 of the cleaning substrate 52, although alternatives are possible. For example, the cleaning substrate 52 may include the moistened area 60 along its entire length L. In certain examples, the moistened area 60 and the dry area 62 respectively have a width W₁, W₂ that is substantially uniform along the length L of the cleaning substrate 52, although alternatives are possible.

The present disclosure also relates to a method of using a tool with a cleaning tape member to clean at least one surface of an optical fiber connector, although alternatives are possible. The cleaning tape member can be used to clean a surface of the connector without using a tool. For example, the cleaning tape member may be used as a cloth or wipe to clean debris from the connector.

The method can include a step of advancing a cleaning tape member to align with the at least one surface of the optical fiber connector. The microcapsules remain intact during advancement of the cleaning tape member. The method can include a step of engaging the cleaning tape member with the at least one surface of the optical fiber connector such that liquid from the microcapsules within the cleaning tape member burst to release the liquid from the microcapsules. The method further includes a step of wiping contaminants from the at least one surface as the cleaning tip is wiped across the at least one surface of the optical fiber connector. That is, the cleaning tape member can be brought into contact with the connector end face and moved with respect to it. The step of wiping can be achieved by a mechanism in the tool for selectively advancing the cleaning tape member along the path to wipe contaminants. The method can further include a step of drying the at least one surface by advancing the cleaning tape member to a dry portion of the substrate. It will be appreciated that any foreign matter removed can be carried away with the cleaning tape member.

The principles, techniques, and features described herein can be applied in a variety of systems, and there is no requirement that all of the advantageous features identified be incorporated in an assembly, system or component to obtain some benefit according to the present disclosure.

From the forgoing detailed description, it will be evident that modifications and variations can be made without departing from the spirit and scope of the disclosure.

What is claimed is:

1. A cleaning tape member for cleaning optical fiber connectors, the cleaning tape member comprising:
liquid-filled microcapsules embedded in the cleaning tape member;
when the cleaning tape member is rubbed in contact with a surface of application, liquid burst from microcapsules within the cleaning tape member by the rubbing pressure and is applied to the surface of application for removing contaminants therefrom.

2. The cleaning tape member of claim 1, wherein the cleaning tape member is attached to a cleaning device comprising a tape dispenser.

3. The cleaning tape member of claim 1, wherein the cleaning tape member includes a plurality of first sections positioned in first discrete lanes along a length of the cleaning tape member, and a plurality of second sections spaced from the plurality of first sections, the plurality of second sections being positioned in second discrete lanes along the length of the cleaning tape member.

4. The cleaning tape member of claim 3, wherein the liquid-filled microcapsules are positioned within each one of the plurality of first sections of the cleaning tape member.

5. The cleaning tape member of claim 4, wherein the plurality of first and second sections provides the cleaning tape member with an alternating wet and dry pattern when the liquid-filled microcapsules are burst.

6. The cleaning tape member of claim 1, wherein the cleaning tape member includes textile fiber.

7. The cleaning tape member of claim 6, wherein the textile fiber used is a cellulosic fiber, a polyamide fiber, a wool fiber or acrylic or modacrylic fibers, or a woven polyester substrate.

8. The cleaning tape member of claim 1, wherein the surface of application includes an end face of an optical fiber connector to remove contaminants therefrom.

9. The cleaning tape member of claim 1, wherein the microcapsules are between about 300 and 600 microns in diameter.

10. The cleaning tape member of claim 1, wherein the liquid is a cleaning agent.

11. The cleaning tape member of claim 10, wherein the cleaning agent comprises methylcyclohexane.

12. The cleaning tape member of claim 10, wherein the cleaning agent comprises d-Limonene.

13. The cleaning tape member of claim 11, wherein the cleaning agent further includes sodium dodecyl sulfate.

14. The cleaning tape member of claim 12, wherein the cleaning agent further includes sodium dodecyl sulfate.

15. The cleaning tape member of claim 13, wherein the liquid includes at least 99% methylcyclohexane and no more than 1% sodium dodecyl sulfate.

16. The cleaning tape member of claim 14, wherein the liquid includes at least 99% methylcyclohexane and no more than 1% sodium dodecyl sulfate.

17. The cleaning tape member of claim 1, wherein at least 50% of the liquid-filled microcapsules contain methylcyclohexane and 50% of the liquid-filled microcapsules contain d-Limonene.

18. The cleaning tape member of claim 1, wherein a percentage of the liquid-filled microcapsules that contain methylcyclohexane is at least within about 10% to about 75%, and the percentage of the liquid-filled microcapsules that contain d-Limonene is at least within about 10% to about 75%.

19. A method of using a tool for cleaning at least one surface of an optical fiber connector, the tool comprising a body; a cleaning tip on the body, the cleaning tip having a distal end portion configured to align the at least one surface with the cleaning tip; and a cleaning tape member disposed in the body of the tool and extending along a path that exposes the cleaning tape member at the distal end portion of the cleaning tip for engaging the at least one surface of the optical fiber connector, the cleaning tape member comprising liquid-filled microcapsules embedded in the cleaning tape member; the method comprising:
a step of advancing the cleaning tape member to align with the at least one surface of the optical fiber connector, wherein the microcapsules remain intact during advancement of the cleaning tape member;
a step of engaging the cleaning tape member with the at least one surface of the optical fiber connector such that liquid from the microcapsules within the cleaning tape member burst to release the liquid from the microcapsules; and
a step of wiping contaminants from the at least one surface as the cleaning tip is wiped across the at least one surface of the optical fiber connector, the step of wiping being achieved by a mechanism in the tool for selectively advancing the cleaning tape member along the path to wipe contaminants.

20. The method of claim 19, wherein the cleaning tape member includes a substrate having a length with alternating wet and dry portions therealong, the liquid-filled microcapsules providing the wet portions of the substrate, and the method further comprising a step of drying the at least one surface by advancing the cleaning tape member to a dry portion of the substrate.
